(19) United States
(12) Patent Application Publication
(10) Pub. No.: US 2019/0032582 A1
(43) Pub. Date: Jan. 31, 2019

(54) DUAL-FUEL COMBUSTION ENGINE

(71) Applicant: GE Jenbacher GmbH & Co OG, Jenbach (AT)

(72) Inventors: Georg TINSCHMANN, Jenbach (AT); Michael HILLEBRECHT, Praha (CZ); Dino IMHOF, Garching (DE)

(21) Appl. No.: 16/061,256

(22) PCT Filed: Dec. 14, 2016
(86) PCT No.: PCT/AT2016/060125

§ 371 Date: Oct. 10, 2018

(30) Foreign Application Priority Data
Dec. 29, 2015 (AT) A51109/2015

(51) Int. Cl. F02D 41/00; F02D 41/40

(52) U.S. Cl. CPC F02D 41/0025; F02D 2200/024; F02D 2200/025; F02D 41/401

(57) ABSTRACT

A dual-fuel internal combustion engine with at least one combustion chamber, wherein the at least one combustion chamber is assigned to an intake valve for a gas-air mixture and an injector (I1 to I4) for liquid fuel, and a control device, which is designed in a switch-over mode to perform a switch-over, that an amount of energy supplied to the at least one combustion chamber through the gas-air mixture is changed, and a supplied amount of liquid fuel and/or a time of the injection of the liquid fuel is changed, and a combustion sensor whose signals are characteristic for the combustion process occurring in the at least one combustion chamber, wherein the control device is designed to carry out the switch-over using a stored relationship between a time progression of the signals of the combustion sensor and an introduced amount of gas-air mixture.

The present invention relates to a dual-fuel internal combustion engine with the features of the preamble of claim 1 and a method for switch-over of a dual-fuel internal combustion engine.

Dual-fuel internal combustion engines are typically operated in two operating modes. A distinction is made between an operating mode with a primary liquid fuel supply (“liquid operation” for short; in the case of the use of diesel as a liquid fuel, it is called “diesel operation”) and an operating mode with a primarily gaseous fuel supply, in which the liquid fuel serves as a pilot fuel for initiating combustion (known as “gas operation”, “pilot operation”, or “ignition jet operation”). The injection of the liquid fuel is also referred to as a pilot injection. An example of the liquid fuel is diesel. It could also be heavy oil or another self-igniting fuel. An example of the gaseous fuel is natural gas. Other gaseous fuels, such as biogas etc. are also suitable.

In pilot operation, a small amount of liquid fuel is introduced as a so-called pilot injection into a combustion chamber of a piston cylinder unit. As a result of the conditions prevailing at the time of injection, the introduced liquid fuel ignites and detonates a mixture of gaseous fuel and air present in the combustion chamber of the piston cylinder unit. The amount of liquid fuel in a pilot injection is typically 0.5-5% of the total amount of energy supplied to the piston cylinder unit in a work cycle of the internal combustion engine.

To clarify the terms, it is defined that the internal combustion engine is operated in pilot operation or in liquid operation. With regard to the control device, the pilot operation of the internal combustion engine is referred to as a pilot mode and a liquid operation of the internal combustion engine is referred to with regard to the control device as a liquid mode. In addition, there is a mixed operation.

The substitution rate indicates the proportion of the energy supplied to the internal combustion engine in the form of the gaseous fuel. Substitution rates of between 98 and 99.5% are targeted. Such high substitution rates require a design of the internal combustion engine, for example in terms of the compression ratio as it corresponds to that of a gas engine. The sometimes conflicting demands on the internal combustion engine for a pilot operation and a liquid operation lead to compromises in the design, for example in terms of the compression ratio.

U.S. Pat. No. 7,313,673 describes a generic internal combustion engine and a generic method. The switch-over is performed by evaluating the signals of a knock sensor as close as possible to the knock limit, so that the switch-over can be performed as quickly as possible. The approximation to the knock limit is necessary because, during the switch-over (unlike outside of the switch-over), the amount of gas-air mixture supplied to a combustion chamber is known only as a precalculated value, but no information exists about deviations. This applies in particular if no sensor is provided for the cylinder pressure progression.

The object of the invention is to provide a generic dual-fuel internal combustion engine and a generic method for switch-over of a dual-fuel internal combustion engine, whereby the switch-over can be performed without approaching the knock limit and thus with low mechanical stress.

This object is achieved by a dual-fuel internal combustion engine with the features of claim 1 and a method for switch-over of a dual-fuel internal combustion engine with the features of claim 8. Advantageous embodiments of the invention are defined in the dependent claims.

In the invention, no approximation to the knock limit is required and less mechanical stress occurs. A rapid and smooth switch-over is possible. Via the stored relationship between
a time progression of the signals of the combustion sensor and
an introduced amount of gas-air mixture,
   it can be checked whether the introduced amount of gas-air mixture matches the setpoint value.

The invention is based on the following relationship: If more gas-air mixture is present in the at least one combustion chamber, then the ignition delay of the pilot injection increases, more liquid fuel is accumulated until ignition and the time progression of the signals of the combustion sensor has a characteristic form (e.g. the so-called pre-maximum attributable to the injection of the liquid fuel is later and stronger). In this way, it can be checked during the switch-over whether the actually introduced amount of gas-air mixture corresponds to the precalculated (setpoint) amount, or whether corrections are necessary, without it being necessary to approach the knock limit.

The time progression of the signals of the combustion sensor can then be analyzed, e.g. when (with respect to a time zero) a first threshold value is reached or exceeded, and how large a maximum of the signal is in a predetermined time window (e.g. from or shortly after the start of injection of the liquid fuel until the top dead center) after exceeding the first threshold value. If the maximum within the considered time window is e.g. relatively late (which is dependent on speed and load, e.g. at a speed of 1,500 rpm and 100% load, a maximum just before the top dead center would be referred to as too late) and/or is relatively strong, this means that the amount of liquid fuel is high. In evaluating the strength of the maximum, the substitution rate should be considered, e.g. at a substitution rate of 80% a relatively strong maximum would be expected, while at a substitution rate of 99%, a relatively weak maximum would be expected.

As time zero e.g. a start time of the injection of the liquid fuel can be used. This can be e.g. the start of the current feed of an injector for the liquid fuel.

The stored relationship may be e.g. determined as follows (the determination may e.g. be made on a prototype of the series of the internal combustion engine, which is designed according to the invention; alternatively, the relationship determined in normal operation can be used individually for each internal combustion engine):
In normal operation (i.e. outside of a switch-over), a specific load, a specific speed and a specific substitution rate are set (e.g. 100% load, speed 1,500 rpm, substitution rate=80%).
The time progression of the signals of the combustion sensor is determined at least in the predetermined time window.
It is considered when, in the predetermined time window, a first threshold value is reached or exceeded and how big a maximum of the signal is in the predetermined time window.
The time of reaching or exceeding the first threshold value and the size of the maximum is linked with the specific load, the specific speed and the specific substitution rate, whereby for this load and this speed via the substitution rate, the relationship between the amount of gas-air mixture and the time progression of the signal of the combustion sensor is established.
This process is repeated for different loads, speeds and substitution rates, resulting in the general relationship between the amount of gas-air mixture and the time progression of the signal of the combustion sensor.

The switch-over of an internal combustion engine according to the invention is performed such that, at least in the predetermined time window, the time progression of the signals of the combustion sensor is determined and compared with the stored time progression for this load and this speed. If the progression (within certain tolerance limits) corresponds, the control device knows that the actual amount of gas-air mixture corresponds to the setpoint value (or, in other words, the actual substitution rate matches the setpoint value). If the progression has a deviation, then it can take appropriate control measures to achieve the desired progression. Depending on the deviation, the appropriate control measures may be a decrease or an increase in the injected amount of liquid fuel.

As a combustion sensor, a knock sensor or a cylinder pressure sensor may be used.

Provision can be made, in a first crank angle range (e.g. −20° to 0° crank angle, whereby 0° corresponds to the top dead center), for the detection and analysis of a signal from the combustion sensor. From this, using the stored relationship, the introduced amount of gas-air mixture can be determined. In a second, later crank angle range (e.g. 0° to 40°), the signal from the combustion sensor can be used to detect knocking.

It can be provided that the control device is designed to close a distance to a knock limit from the chronological progression of the signals of the combustion sensor in the first crank angle range. If the time progression shows e.g. a maximum that is earlier in the first crank angle range and larger than expected, this indicates that the distance to the knock limit is low. The time of the injection of the liquid fuel can be corrected accordingly (later in the example given) to increase the distance to the knock limit.

Typically, an internal combustion engine has a plurality of combustion chambers. The invention may be implemented on a cylinder-specific basis, i.e. for each cylinder, independent of the other cylinders.

A supplied amount of liquid fuel and the combustion process can be checked individually for each cylinder.

The invention can preferably be used in a stationary internal combustion engine, for marine applications or mobile applications such as so-called “non-road mobile machinery” (NRMM), preferably designed as a reciprocating piston engine. The internal combustion engine can be used as a mechanical drive, e.g. for operating compressor systems or coupled with a generator to a genset for generating electrical energy. The internal combustion engine preferably comprises a plurality of combustion chambers with corresponding intake valves and injectors. Each combustion chamber can be controlled individually.

The invention is discussed with reference to the figures.

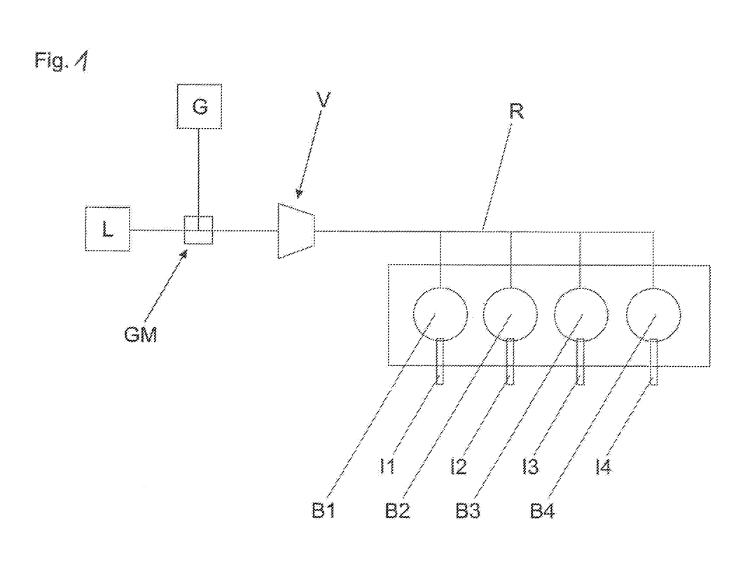

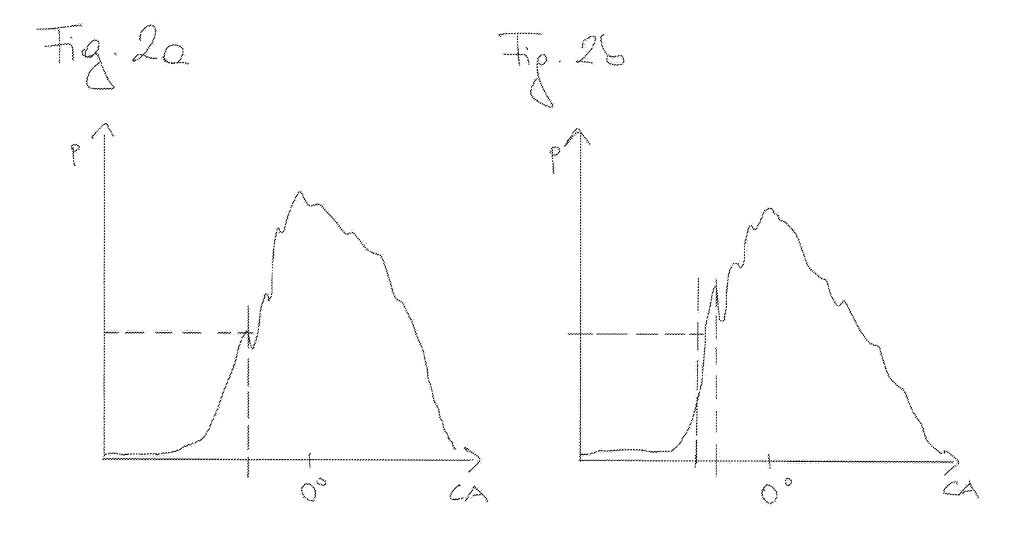

FIG. 1 shows schematically an internal combustion engine according to the invention. In this example, it has four combustion chambers B1 to B4, which can be supplied with liquid fuel, in this case diesel, via the injectors I1 to I4. The intake valves for the gas-air mixture are not shown.

To create the gas-air mixture, a central gas mixer GM is provided, which is connected to an air supply L and a gas reservoir G, e.g. a tank. Via a gas-air mixture supply R, the gas-air mixture produced in the central gas mixer GM is supplied to the combustion chambers B1 to B4. Downstream of the gas mixer GM, a compressor V of a turbocharger (mixed-charged internal combustion engine) is also provided. However, the gas mixer GM could also be arranged downstream of the compressor V in the air supply (air-charged internal combustion engine). The number of combustion chambers B1 to B4 is purely exemplary.

The invention can be used in dual-fuel internal combustion engines with 2, 4, 6, 8, 10, 12, 14, 16, 18, 20, 22 or 24 combustion chambers.

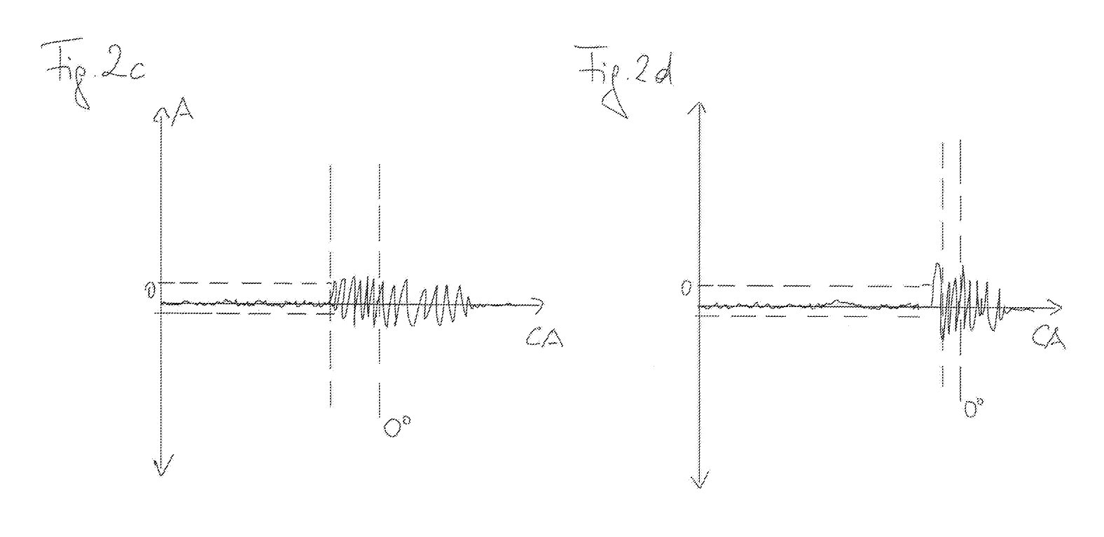

FIG. 2a shows the time progression of a combustion sensor (here in the form of a cylinder pressure sensor for the cylinder pressure P in the combustion chamber of a selected piston cylinder unit) over the entire crank angle range (CA=crank angle).

We can recognize the formation of a first maximum at a specific crank angle with a specific strength, which is attributable to the introduction of liquid fuel. The first time window should be positioned so that this maximum can be detected.

FIG. 2b shows the progression as in FIG. 2a but with a later and stronger first maximum (for comparison, dashed reference lines are drawn at the crank angle and cylinder pressure corresponding to the position and strength of the first maximum of FIG. 2a), suggesting a longer ignition delay and thus a larger amount of gas in the gas-air mixture.

FIG. 2c shows the time progression of a combustion sensor in the form of a knock sensor. (An amplitude for the solid-borne sound over the entire range of crank angle is shown.) Recognizable here is also the formation of a first maximum, which is attributable to the introduction of liquid fuel. The first time window should be positioned so that this maximum can be detected.

FIG. 2d shows the progression as in FIG. 2c but with a later and stronger first maximum (for comparison, dashed reference lines are drawn at the crank angle and cylinder pressure corresponding to the position and strength of the first maximum of FIG. 2c), suggesting a longer ignition delay and thus a larger amount of gas in the gas-air mixture.

1. A dual-fuel internal combustion engine with at least one combustion chamber, wherein the at least one combustion chamber is assigned to an intake valve for a gas-air mixture and an injector (I1 to 14) for liquid fuel, and a control device, which is designed in a switch-over mode to perform a switch-over, wherein
an amount of energy supplied to the at least one combustion chamber through the gas-air mixture is changed, and
a supplied amount of liquid fuel and/or a time of the injection of the liquid fuel is changed,
and a combustion sensor whose signals are characteristic for the combustion process occurring in the at least one combustion chamber, characterized in that the control device is designed to perform the switch-over using a stored relationship between
a time progression of the signals of the combustion sensor and
an introduced amount of gas-air mixture

2. A dual-fuel internal combustion engine according to claim 1, wherein the combustion sensor is a knock sensor.

3. A dual-fuel internal combustion engine according to claim 1, wherein the combustion sensor is a cylinder pressure sensor.

4. A dual-fuel internal combustion engine according to at least one of the preceding claims, wherein the control device is designed to detect a signal of the combustion sensor in a first crank angle range and to deduce from it the amount of gas-air mixture introduced.

5. A dual-fuel internal combustion engine according to the preceding claim, wherein the control device is designed to detect a signal of the combustion sensor in a second, later crank angle range and thus to detect knocking.

6. A dual-fuel internal combustion engine according to at least one of the preceding claims, wherein the control device is designed to close a distance to a knock limit from the chronological progression of the signals of the combustion sensor in the first crank angle range.

7. A dual-fuel internal combustion engine according to at least one of the preceding claims, wherein a plurality of piston cylinder units with combustion chambers are provided, and the control device is designed to check a supplied amount of liquid fuel and the combustion process in a cylinder-specific manner.

8. A method for switch-over of a dual-fuel internal combustion engine, in which switch-over
an amount of energy supplied to an at least one combustion chamber through a gas-air mixture is changed, and
a supplied amount of liquid fuel and/or a time of an injection of the liquid fuel is changed,
characterized in that the switch-over is performed using a stored relationship between
a time progression of the signals of a combustion sensor and
an introduced amount of gas-air mixture
